(19) United States
(12) Patent Application Publication
(10) Pub. No.: US 2014/0015764 A1
(43) Pub. Date: Jan. 16, 2014

(54) Display

(71) Applicants: Joni K. Arola, Tampere (FI); Pasi J. Laine, Lempaala (FI); Jari O. Saukko, Tampere (FI)

(72) Inventors: Joni K. Arola, Tampere (FI); Pasi J. Laine, Lempaala (FI); Jari O. Saukko, Tampere (FI)

(73) Assignee: Nokia Corporation

(21) Appl. No.: 13/548,562

(22) Filed: Jul. 13, 2012

(51) Int. Cl. G06F 3/041; H01J 9/00; G09G 3/00

(52) U.S. Cl. 345/173; 345/30; 445/24

(57) ABSTRACT

Methods and apparatus for an electronic display. A display assembly comprises an electronic display device comprising an upper and a lower substrate. The upper substrate extends beyond the lower substrate and joins with at least a portion of a housing of a user device to enclose a space within the user device in which the display assembly is enclosed.

### TECHNICAL FIELD

The present invention relates generally to device displays. More particularly, the invention relates to a user display panel whose primary window is an upper substrate of a display device.

### BACKGROUND

Mobile user devices such as telephones, cameras, media players and the like typically employ relatively large user displays that are often touch sensitive. The ability of mobile devices to perform multiple different functions has steadily increased, and the desire of users for smaller and thinner devices has also increased. Manufacturers have increased integration of components in mobile devices and have endeavored to manufacture their devices to be small and thin. Factors influencing the difficulty and cost of integrating components include, naturally enough, the number of components that must be integrated. It will also be recognized that designing and manufacturing devices to be small and thin becomes more difficult if more components must be included in the devices.

FIG. 1 illustrates a prior-art assembly 100. The assembly 100 comprises upper and lower substrates, such as a thin film transistor (TFT) array substrate 102 and a color filter 104, with polarization layers 106A and 106B on the TFT array substrate 102 and the filter 104, respectively. The color filter 104 is typically glass or plastic. The assembly further comprises a top window 108, protecting the assembly and serving as a seal from contaminants. The top window 108 is typically separated from the polarization layer 106A by a spacing 110, which may be, for example, an airspace or a laminate. In the example shown, the top glass 108 extends beyond the color filter 104, so as to extend to be in contact with a frame of a device. The top glass serves, with the frame of the device, to enclose an area in which the display assembly 100 is contained. The need for the top glass and the additional spacing contributes to the thickness of prior art designs such as the design presented here. In prior-art designs such as that presented here, the combined thickness of the TFT array substrate and color filter substrate typically ranges from less than 0.2 mm to approximately 0.5 mm, the spacing, occupied by an air gap or by a lamination, typically ranges from 0.2 mm-0.5 mm, and the thickness of the top window 108 is typically from 0.5 mm upwards if the top window 108 is glass, and approximately 1.1 mm if the top window 108 is poly(methyl methacrylate) (PMMA). The thickness of the spacing 110 and the separate top window contribute to the thickness of the design, and if a laminate is used in the spacing, the cost of the laminate contributes to the overall cost of the design.

### SUMMARY

The foregoing and other problems are overcome, and other advantages are realized, in accordance with the exemplary embodiments of this invention.

In one embodiment of the invention, an electronic display device comprises a lower substrate and an upper substrate affixed to the lower substrate. The upper substrate serves as a viewing window to the electronic display device.

In another embodiment of the invention, a user device comprises a user device housing and an electronic display device disposed within the user device housing. The electronic display device comprises an upper and a lower substrate, wherein the upper substrate serves as a viewing window to the electronic display device.

In another embodiment of the invention, a method comprises forming an electronic display device comprising an upper substrate and a lower substrate and disposing the electronic display device within a user device such that the covering panel joins with at least a portion of a housing of the user device to enclose a space within which the electronic display device is contained. The upper substrate provides a viewing window to the electronic display device.

These and other embodiments of the invention are described below with particularity.

### BRIEF DESCRIPTION OF THE DRAWINGS

FIG. 1 illustrates a prior-art display assembly;

FIG. 2 illustrates a display assembly according to an embodiment of the present invention;

FIG. 3 illustrates additional elements of the display assembly of FIG. 2;

FIG. 4 illustrates a display assembly according to an embodiment of the present invention;

FIG. 5 illustrates a display assembly according to an embodiment of the present invention;

FIGS. 6 and 7 illustrate mounting of a display assembly in a device according to embodiments of the present invention;

FIGS. 8A-8E illustrate alternative views of a display assembly according to embodiments of the present invention;

FIGS. 9A-9D illustrate alternative views of a display assembly mounted in a device according to embodiments of the present invention; and

FIG. 10 illustrates a process according to an embodiment of the present invention.

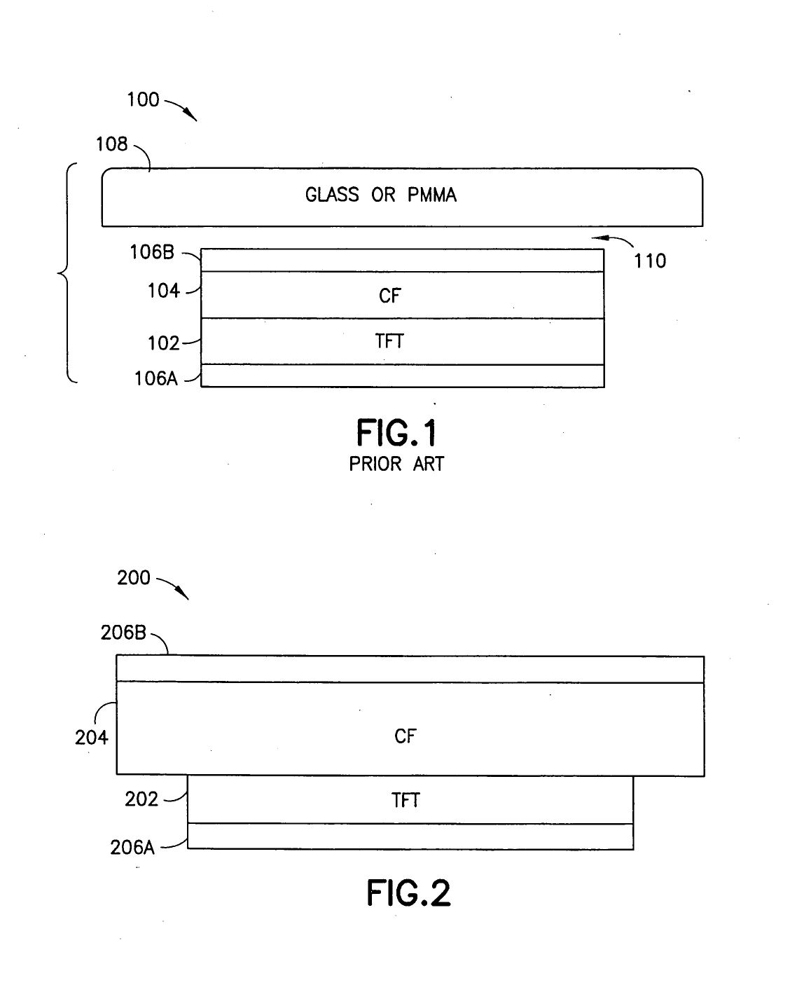

### DETAILED DESCRIPTION

As noted above, the difficulty and cost of integrating components, and the difficulty of designing small and thin devices, increases as increasing numbers of devices are involved. It follows that eliminating components will decrease the cost of integration and simplify the design of smaller devices.

As noted above, one important component of many mobile devices is the user display, particularly a touch sensitive display. A touch sensitive display may comprise a display device topped with a covering panel. In one or more embodiments of the invention, substantially all, such as 90% or more, of a surface of the display device, may contact a surface of the covering panel. The contact between the covering panel and the display device may be direct, with no air gap or other separator, such as a laminate, separating the display device and the covering panel.

In one or more embodiments of the invention, the display device may be a thin film transistor liquid crystal display whose upper substrate is a color filter. In one or more embodiments of the invention, the color filter may be used as the front window of the display, with no separate covering glass being used. In some mobile device designs, a display comprises a thin film transistor display, such as an organic light emitting diode (OLED) display whose upper substrate is an encapsulating glass, and in one or more embodiments of the invention, the encapsulating glass serves as the display front window. In one or more embodiments of the invention, the color filter, or the encapsulation, may extend past the thin-film transistor to the device enclosure, to provide for protection of the display and prevention of outside elements or contamination. One or more embodiments of the present invention therefore provide for a display design so that a functional portion of the display device also serves as the window. It will be recognized, however, that the presentation of embodiments comprising thin film transistor displays is by way of example only, and that embodiments of the present invention may be used with any suitable technology, such as bi-stabile technologies.

FIG. 2 illustrates a display assembly 200 according to an embodiment of the present invention. The display assembly 200 may suitably be implemented as a touch sensitive display and comprises as a lower substrate a thin film transistor display array substrate 202, and, as an upper substrate, a color filter 204. In the present exemplary embodiment, the thin film transistor display array substrate 202 and the color filter 204 are affixed to polarizers 206A and 206B, respectively. The polarizers 206A and 206B may be of any suitable polarization material, such as polarizing glass or a polarizing coating. The color filter 204 is shown here as extending beyond the thin film display 202, providing both filtering and serving to enclose the area in which the assembly 200 is contained. The color filter 204 may be fashioned of a suitable high strength material, so that it is sufficiently rugged to serve as a window to the display, resisting breaking and otherwise protecting against impacts and other hazards.

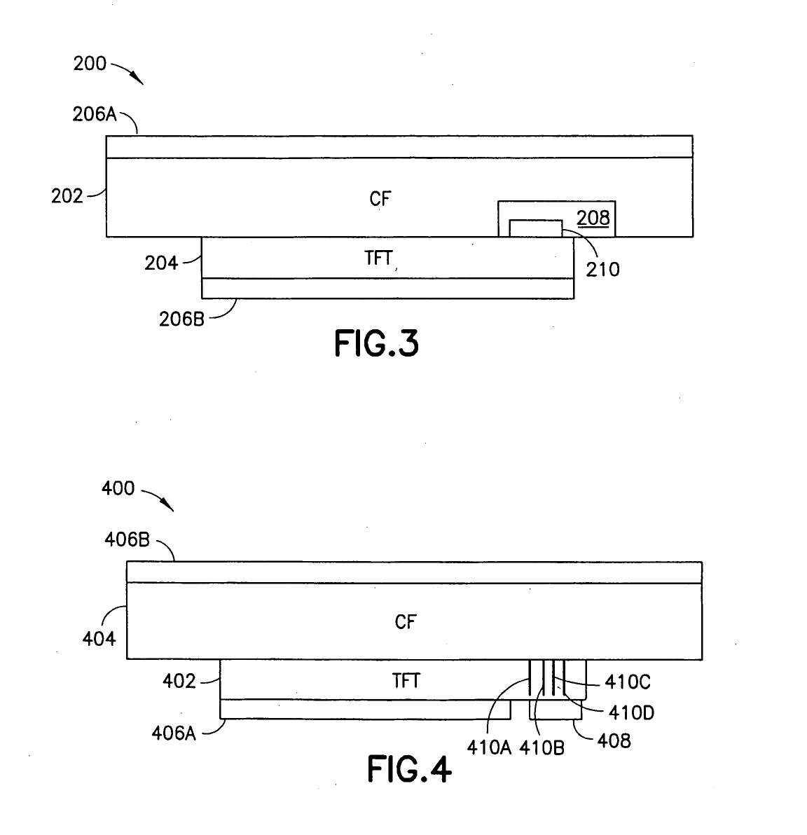

FIG. 3 illustrates another view of the display assembly 200, with the view presented in FIG. 3 being rotated 90 degrees in the horizontal plane from that presented in FIG. 3. It can be seen in the view presented in FIG. 3 that the display assembly 200 may be integrated with electronic components as desired, saving thickness by enclosing components within the display assembly. In the present view, a lower substrate comprising an array substrate 202, which may be a TFT or OLED display, can be seen. Also present are an upper substrate, which may be a color filter 204, and polarizers 206A and 206B, as well as a chamber 208 within the color filter 204, providing room for an electronic component 210. The electronic component 210 may be a flexible printed circuit, and may, be, for example a display driver integrated circuit (IC). It will be recognized that multiple components such as the component 210 may be enclosed within the chamber 208 if desired, provided that they are sufficiently small so that they can be placed so as to function properly in the space available in the chamber 208. The electronic component 210, or multiple electronic components if such a design is chosen, may be bonded to an upper glass of the array substrate 202.

FIG. 4 illustrates an alternative display assembly 400 according to an embodiment of the present invention. The assembly 400 may suitably be implemented as a touch sensitive display and comprises a thin film transistor display array substrate 402, color filter 404, and polarizers 406A and 406B. The color filter 404 and polarizer 406B extend beyond the thin film transistor display 402, to serve as a front window to the display assembly and to mate with a frame of a device in which the display assembly is used in order to enclose an area in which the display assembly 400 is contained.

In the exemplary embodiment shown, the polarizer 406A does not extend all the way to both edges of the thin film transistor display array substrate 402. Instead, a portion of the thin film transistor display 402 is left exposed to accommodate an electronic component 408. The electronic component 408 may be, for example, a flexible printed circuit and may be a display driver IC. In the illustrated embodiment, vias 410A-410D are fabricated within the TFT array substrate so that the electronic component can be placed on the opposite side of the TFT display 402 from the color filter 404.

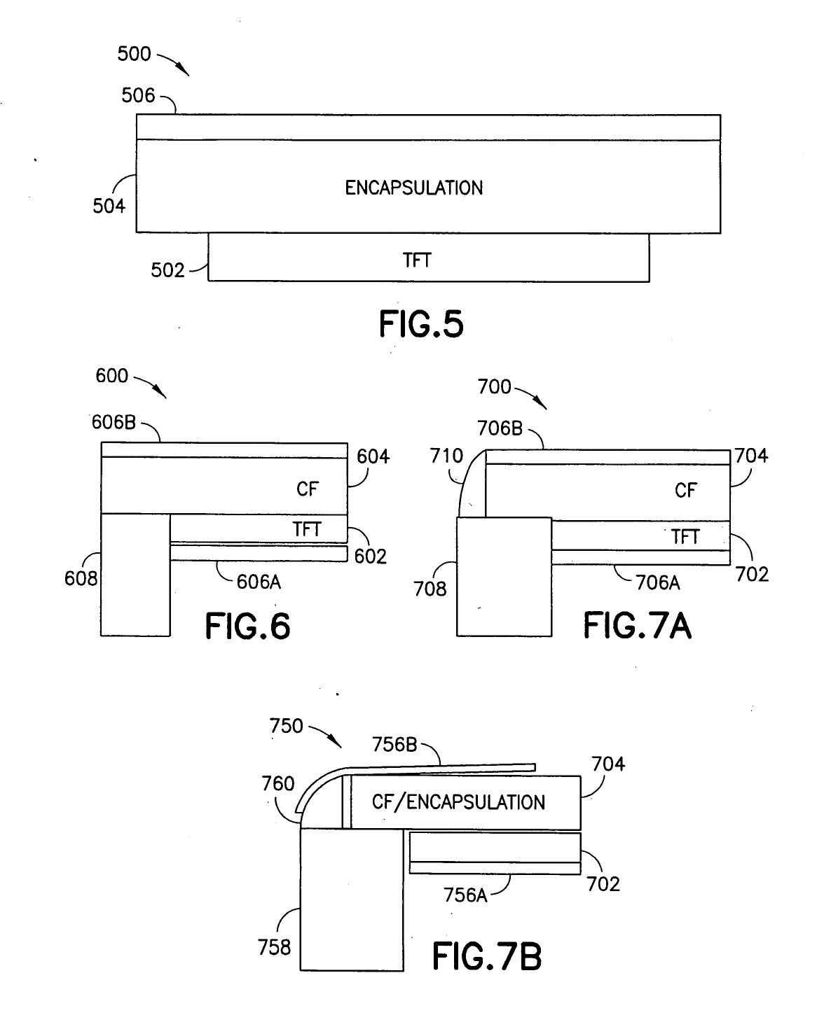

FIG. 5 illustrates a display assembly 500 according to another embodiment of the present invention. The display assembly 500 may suitably be implemented as a touch sensitive display and comprises as a lower substrate a TFT display array substrate 502. The display assembly 500 further comprises, as an upper substrate, an encapsulating glass 504, which may take the form of an organic light emitting diode (OLED) display. In the example presented here, the display assembly 500 also includes a polarizer 506A. The encapsulating glass extends beyond the TFT array substrate 502, to allow mating with a frame of a device in which the display assembly 500 is used, in order to provide protection for the display assembly 500 and sealing of the space in which the display assembly 500 is contained.

FIGS. 6, 7A, and 7B illustrate exemplary configurations of display assemblies according to embodiments of the present invention. FIG. 6 illustrates an assembly 600, which may suitably be implemented as a touch sensitive display and comprises upper and lower substrates comprising a TFT display array substrate 602 and a color filter 604, and polarizers 606A and 606B. The color filter 604 extends beyond the TFT display array substrate 602. The TFT display array substrate 602 abuts against a portion of a device chassis 608, while the color filter extends over the device chassis 608. The color filter 604 provides a seal with the device chassis 608.

FIG. 7A illustrates an assembly 700 which may suitably be implemented as a touch sensitive display and comprises upper and lower substrates comprising a TFT display 702 and a color filter 704, and polarizers 706A and 706B. The color filter 704 extends beyond the TFT display 702. The TFT display array substrate 702 abuts against a portion of a device chassis 708, while the color filter extends over the device chassis 708 and abuts against a device frame 710, configured to surround the assembly 700.

FIG. 7B illustrates an assembly 750, which may suitably be implemented as a touch sensitive display and comprises upper and lower substrates comprising a TFT display array substrate 752 and a color filter 754, as well as upper and lower polarizing films 756A and 756B. Here as well, the TFT display array substrate 752 abuts against a portion of a device chassis 758, while the color filter extends over the device chassis 758 and abuts against a device frame 760, configured to surround the assembly 700.

The particular configuration here showing a separate chassis and frame is exemplary only, and it will be recognized that any number of configurations may be used, such as a configuration using a combined chassis and frame.

In the examples illustrated in FIGS. 7A and 7B, the color filter provides a seal with the device chassis, covering the TFT display array substrate, with the frame serving to further secure the color filter and the TFT array substrate which is bonded with the color filter.

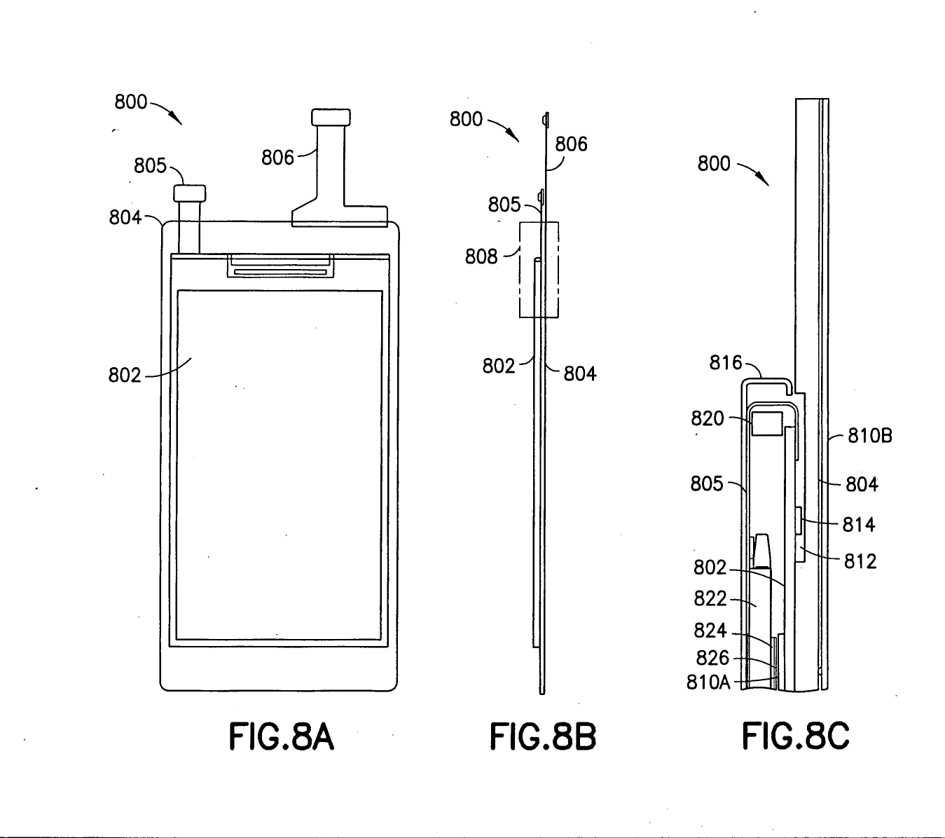

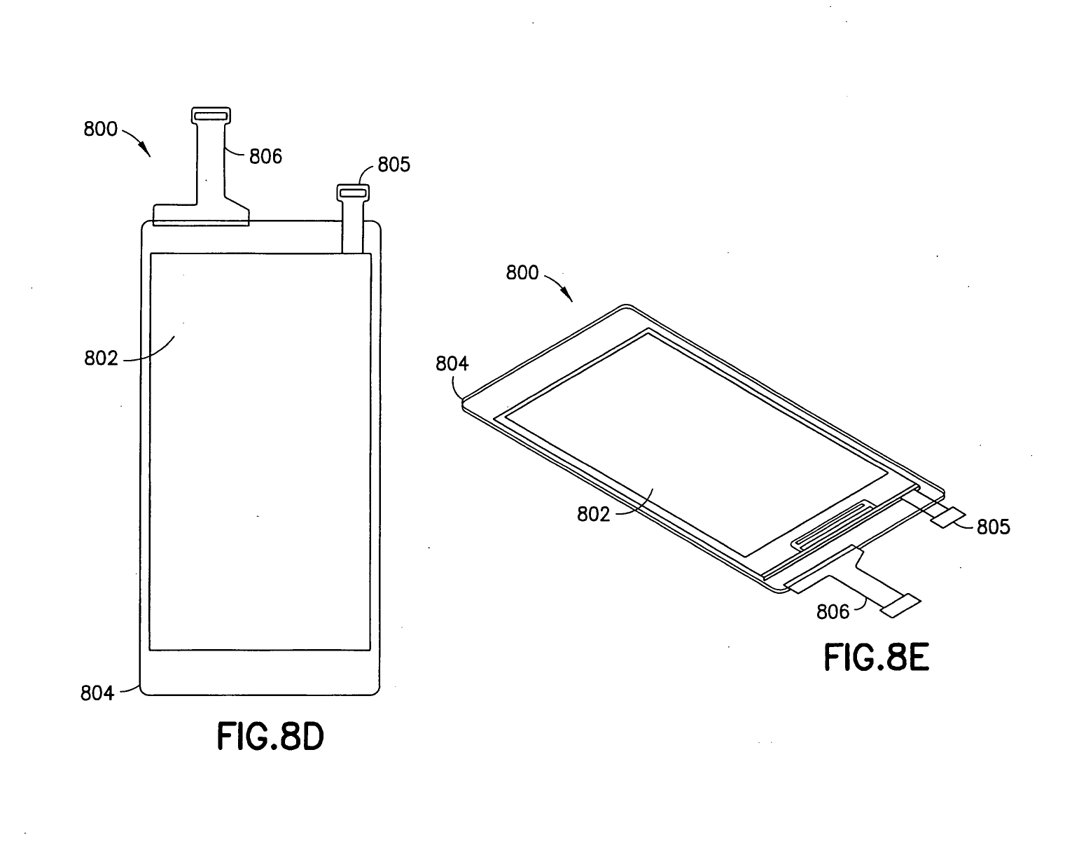

FIGS. 8A-8E illustrate alternative views of a display assembly 800 according to embodiments of the present invention, where FIG. 8C is a magnified view of portion 808 of FIG. 8B. The display assembly 800 may suitably be implemented as a touch sensitive display. FIG. 8A illustrates a front view of the assembly 800, showing a lower substrate comprising a TFT display array substrate 802 as it appears through an upper substrate 804, which may be, for example, a color filter or an encapsulating glass such as an OLED. FIG. 8A also illustrates ribbon cables 805 and 806. FIG. 8B illustrates a side view of the assembly 800, showing side views of the TFT display 802 and the upper substrate 804, as well as the ribbon cables 805 and 806. The upper substrate 804 can easily be seen to extend beyond the TFT display 802 in this view.

FIG. 8C illustrates a magnified view of the portion 808 of the display assembly 800, showing its various components, and also showing other components that are integrated with the display assembly 800 into a display module. The TFT display array substrate 802 and the upper substrate 804 can be seen, along with polarizers 810A and 810B. A chamber 812 and electronic component 814 can be seen. The display assembly 800 is shown here as integrated into a display module comprising additional components including a housing 816 and the ribbon cable 805 folded back along the housing, with a spacer 820 between the ribbon cable 805 and the TFT display 802. The display module also comprises an electronics package 822 and layers 824 and 826.

FIGS. 8D and 8E present alternative views of the display assembly 800, with FIG. 8D illustrating a rear view and FIG. 8E illustrating a horizontal view. In each view, the TFT display array substrate 802 and the upper substrate 804 can be seen, as well as the ribbon cables 805 and 806. In FIG. 8D, the rear of the TFT display array substrate 802 can be seen directly, and the upper substrate 804 can be seen to extend beyond the TFT display 802.

A display assembly such as the display assembly 800 may be used as part of a user device such as a wireless communication user equipment, media player, camera, tablet computer, or any of a number of other types of devices. A display assembly may be joined to other otherwise disposed in a device chassis, frame, or other similar components or combinations of components, in order to provide an outer window to the user device without a need for a protective glass. The display assembly provides a front or top layer that mates with appropriately configured components of the chassis or frame to form an enclosure, sealing the space in which the display assembly and other electronic components of the user device are disposed.

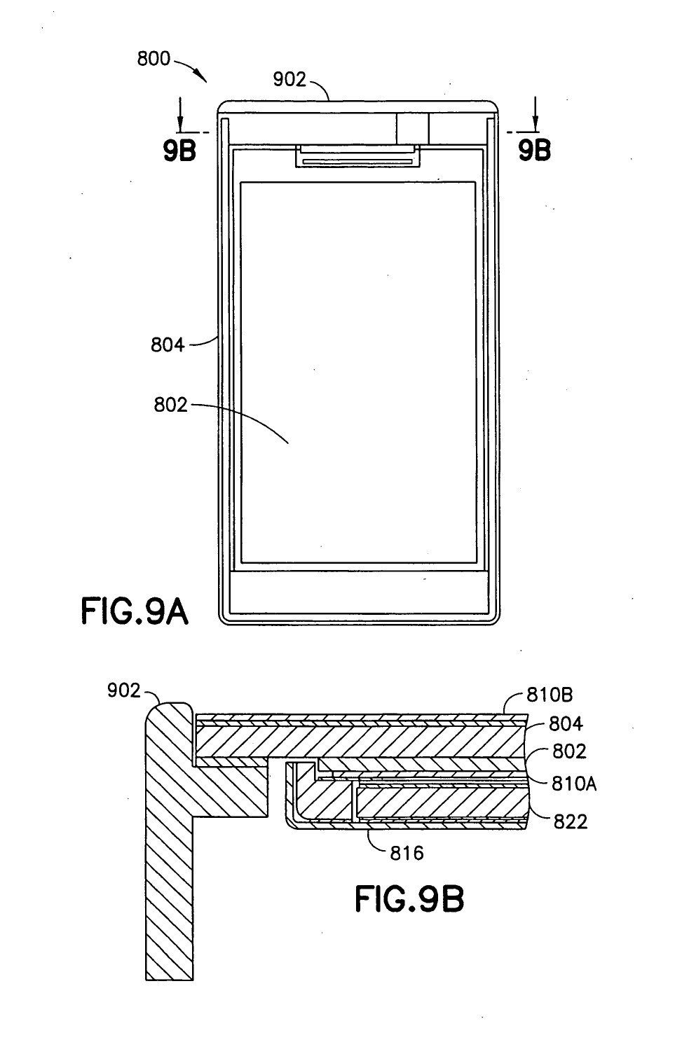

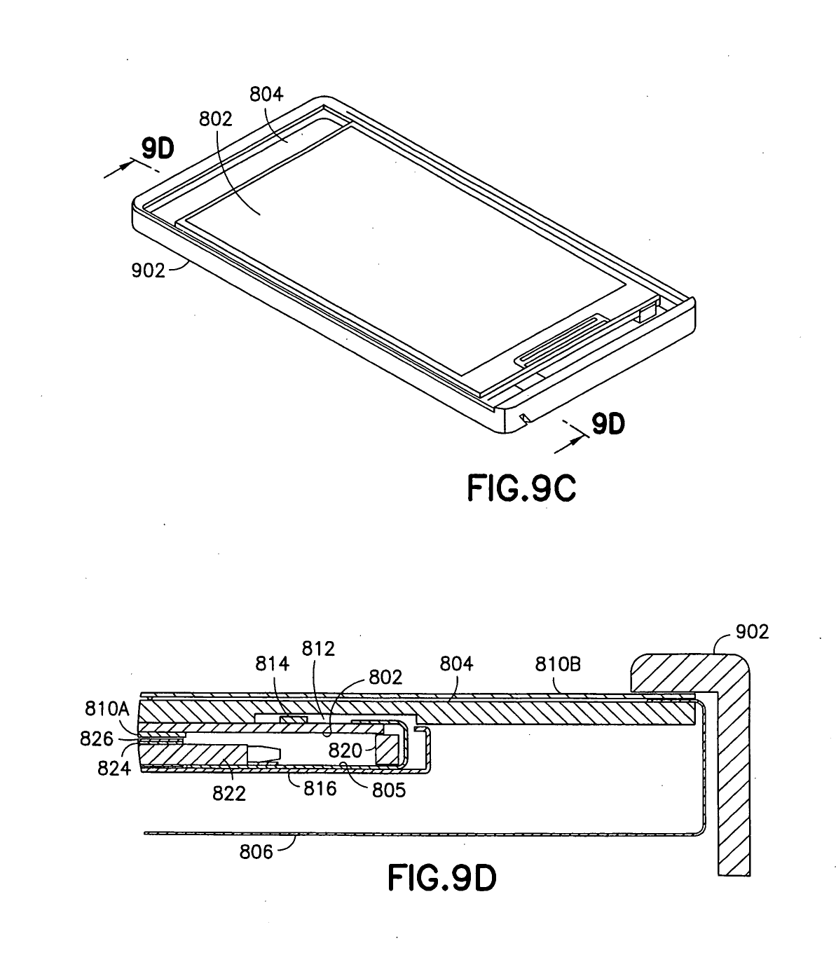

FIGS. 9A-9D illustrate views of the display assembly 800 as it is assembled into a display module which is then placed in a device frame 902. The device frame FIG. 9A illustrates a front view of the display assembly 800, in which the TFT display array substrate 802 can be seen through the upper substrate 804. The display assembly 800 is enclosed within the frame 902, which mates with the upper substrate 804, sealing an enclosure containing the display assembly 800 and the other components.

FIG. 9B illustrates a cross section of the display assembly 800 of FIG. 9A, looking in the indicated direction. The assembly TFT display 802, upper substrate 804, polarizers 810A and 810B can be seen, along with the housing 816 and electronics package 822 of FIG. 8C.

FIG. 9C illustrates a perspective view of the display assembly 800 as it is assembled into the display module and placed in the device housing 902. The TFT array substrate 802 can be seen through the upper substrate 804. FIG. 9D presents a cross section of the display assembly 800, of FIG. 9C, looking in the indicated direction. The various components presented in FIG. 8C, namely, 802, 804, 810A and 810B, 812, 814, 816, 820, and 822 can be seen, enclosed in a device housing 904, which is in turn enclosed within the frame 902.

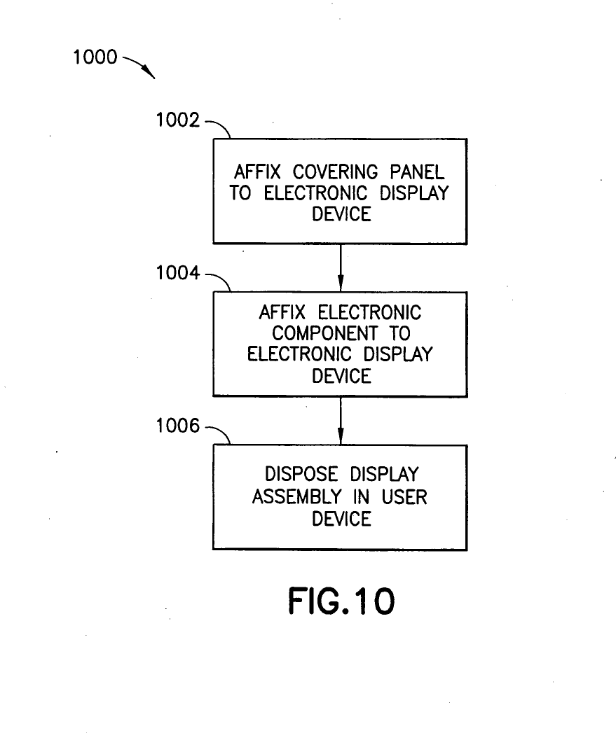

FIG. 10 illustrates a process 1000 according to an embodiment of the present invention. At step 1002, an electronic display device is formed, comprising upper and lower substrates. The display device may suitably be a touch sensitive display device. The electronic display device may be a thin film transistor display array substrate, and the upper substrate may extend beyond the lower substrate. In one embodiment, the electronic display device may be a liquid crystal display with the upper substrate being a color filter, and in another embodiment the electronic display device may be an organic light emitting diode display (OLED) with the upper substrate being an OLED encapsulating glass. Polarization layers may be disposed on the electronic display device and the covering panel.

At step 1004, an electronic component, such as a flexible printed circuit, is affixed to the electronic display device. The electronic component may suitably be a display driver. In one embodiment of the invention, the electronic component may be encompassed within a chamber provided in the covering panel, and in another embodiment, the electronic component may be affixed to the electronic display device on a side of the electronic display device opposite to the covering panel, and at least one via may be provided in the electronic display device to accommodate operation of the electronic component.

At step 1006, a display assembly comprising the electronic display device is disposed in a user device such that the upper substrate provides a viewing window to the electronic display device, and joins with at least a portion of a housing of the user device to enclose a space within which the display assembly is contained.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

We claim:

1. An electronic display device comprising:
a lower substrate;
an upper substrate affixed to the lower substrate; and
wherein the upper substrate serves as a viewing window to the electronic display device.

2. The electronic display device of claim 1, wherein the electronic display device is a thin film transistor display and wherein the lower substrate is a thin film transistor display array substrate.

3. The electronic display device of claim 1, wherein at least one edge of the upper substrate extends beyond at least one edge of the lower substrate.

4. The electronic display device of claim 2, wherein the upper substrate is a color filter.

5. The electronic display device of claim 2, wherein the covering panel is an organic light emitting diode encapsulating layer.

6. The electronic display device of claim 2, further comprising an electronic component affixed to a surface of the lower substrate.

7. The electronic display device of claim 6, wherein the electronic component is a flexible printed circuit.

8. The electronic display device of claim 6, wherein the covering panel comprises a chamber, and wherein the electronic component is affixed to thin film transistor lower substrate and accommodated within the chamber.

9. The electronic display device of claim 2, wherein the electronic component is affixed to the electronic display device on an opposite side of the electronic display device from the covering panel and wherein the electronic display device comprises at least one via to accommodate operation of the electronic component.

10. The electronic display device of claim 1, wherein the electronic display device is a touch sensitive display device.

11. A user device comprising:
a user device housing;
an electronic display device disposed within the user device housing;
wherein the electronic display device comprises an upper and a lower substrate, wherein the upper substrate serves as a viewing window to the electronic display device.

12. The user device of claim 11, wherein the upper substrate extends beyond the lower substrate.

13. The user device of claim 12, wherein the upper substrate extends to join with at least a portion of the user device housing to form a sealed enclosure.

14. The user device of claim 11, wherein the lower substrate is a thin film transistor display array substrate.

15. The user device of claim 12, wherein the covering panel is a color filter.

16. The user device of claim 12, wherein the electronic display device is a thin film transistor organic light emitting diode device and the covering panel is an encapsulating glass.

17. The user device of claim 12, wherein the electronic display device is a touch sensitive display device.

18. A method comprising:
forming an electronic display device comprising an upper substrate and a lower substrate; and
disposing the electronic display device within a user device such that the upper substrate joins with at least a portion of a housing of the user device to enclose a space within which the electronic display device is contained, wherein the upper substrate provides a viewing window to the electronic display device.

19. The method of claim 18, wherein the upper substrate extends beyond the lower substrate.

20. The method of claim 18, wherein the electronic display device is a thin film transistor display.

21. The method of claim 20, wherein the electronic display device is a thin film transistor liquid crystal display and the upper substrate is a color filter.

22. The method of claim 20, wherein the electronic display device is a thin film transistor organic light emitting diode display and the upper substrate is an encapsulating glass.

23. The method of claim 18, wherein the electronic display device comprises a touch sensitive display device.
